(19) United States
(12) Patent Application Publication
(10) Pub. No.: US 2025/0272727 A1
(43) Pub. Date: Aug. 28, 2025

(54) ONLINE SALES METHOD AND PLATFORM

(71) Applicant: Lynn MAAS, Singapore (SG)

(72) Inventor: Lynn MAAS, Singapore (SG)

(21) Appl. No.: 19/065,073

(22) Filed: Feb. 27, 2025

Related U.S. Application Data
(60) Provisional application No. 63/558,164, filed on Feb. 27, 2024.

(51) Int. Cl. G06Q 30/0601; G06Q 10/083

(52) U.S. Cl. CPC G06Q 30/0601; G06Q 10/083

(57) ABSTRACT

An online sales platform, which includes: a front-end online sales software application being installed on a device of a consumer, the device of the consumer comprising a display screen, an input device, a processor, a communication interface and memory.

### CROSS REFERENCE TO RELATED APPLICATIONS

This application claims the benefit of priority of U.S. Provisional Patent Application No. 63/558,164, filed Feb. 27, 2024, the contents of which are all incorporated herein by reference in their entirety.

### FIELD OF THE INVENTION

This invention relates to an online sales method. The invention also relates to an online sales platform.

### BACKGROUND OF THE INVENTION

In this specification, the term “offering” should be broadly interpreted to include goods and services, the term “delivery” should be broadly interpreted to include a fulfillment, the term “platform” should be understood to include a system, and the term “service” should be understood to include a so-called experience and a so-called asset.

The terms vertical market software and horizontal market software are known terms in the software industry. Vertical market offerings refer to industry-specific goods and/or services, such as goods and/or services for the food and beverage, entertainment, healthcare, and telecommunications industries. Conversely, horizontal market offerings refer to cross-industry goods and/or services, such as delivery services and accounting services that apply across unrelated vertical market offerings.

The inventors are aware of online sales platforms that address vertical market offerings and horizontal market offerings separately.

The inventors have identified a need for an integrated online sales platform and the present invention aims to provide such an integrated online sales platform.

### SUMMARY OF THE INVENTION

According to the invention there is provided an online sales platform, the online sales platform comprising:
a front-end online sales software application being installed on a device of a consumer, the device of the consumer comprising a display screen, an input device, a processor, a communication interface and memory;
a horizontal market-place supplier and a vertical market-place supplier; and
an online sales server of a seller comprising a display screen, an input device, a processor, a communication interface and memory, the online sales server having installed thereon a back-end online sales software application and a database in data communication with the front-end online sales software application and both the horizontal and vertical market-place suppliers, the online sales server being operable to:
   present the consumer with a vertical market offering at the front-end online sales software application;
   present the consumer with a horizontal offering at the front-end online sales software application; receive a vertical market order from the consumer;
   receive a horizontal market order from the consumer; receive a preferred delivery slot from the consumer;
   receive an available delivery slot from a delivery partner;
   receive payment for the vertical market order and the horizontal market order via a payment gateway;
   compare the preferred delivery slot with the available delivery slot and in case of a match, settle on an agreed delivery slot, and in case of a mismatch, receive any one or more of: a revised preferred delivery slot, and a revised available delivery slot to settle on an alternative agreed delivery slot; and delivering the vertical market order and the horizontal market order to the consumer in the agreed delivery slot.

In accordance with another aspect of the invention, there is provided an online sales method, the method being performed by a seller of an online sales platform, the method comprising the steps of:
presenting a consumer with an offering via a front-end online sales software application being installed on a device of a consumer;
receiving an order selection from the consumer in response to the offering;
receiving a consumer delivery preference from the consumer;
receiving a delivery partner preference from a delivery partner;
matching the consumer delivery preference to the delivery partner preference;
receiving payment for the order selection; and
delivering the order to the consumer.

More particularly, according to one aspect of the invention, there is provided an online sales method, the method being performed by a seller of an online sales platform, and including the steps of:
presenting a consumer with a vertical market offering at a front-end online sales software application;
receiving a vertical market order from the consumer at an online sales server having installed thereon a back-end online sales software application and a database;
receiving a preferred delivery slot from the consumer at the back-end online sales software application;
receiving an available delivery slot from a delivery partner at the back-end online sales software application;
receiving payment for the vertical market order via a payment gateway;
comparing the preferred delivery slot with the available delivery slot and in case of a match, settle on an agreed delivery slot, and in case of a mismatch, receive any one or more of: a revised preferred delivery slot, and a revised available delivery slot to settle on an alternative agreed delivery slot; and
delivering the vertical market order to the consumer in the agreed delivery slot.

The vertical market offering may include goods and services specific to an industry, trade, or profession. For example, the vertical market offering may include an artisanal product offering.

The online sales method may include presenting the consumer with a horizontal market offering at the front-end online sales software application; receiving a horizontal market order from the consumer at the back-end online sales software application; receiving payment for the horizontal market order via the payment gateway; and delivering the horizontal market order to the consumer in the agreed delivery slot.

The horizontal market offering may include goods and services that meet the needs of a wide range of buyers across various industries. For example, the horizontal market offering may include any of a booking offering, a product-as-a-service offering, and a financial-rewards offering.

The online sales method may include registering a consumer and a supplier and uploading a consumer profile and a supplier profile at the back-end online sales software application.

Registering a supplier and uploading a supplier profile may include registering a vertical market-place supplier and a horizontal market-place supplier and uploading a vertical market-place supplier profile and a horizontal market-place supplier profile to the back-end online sales software application.

The online sales method may include uploading a vertical market-place supplier catalogue and a horizontal market-place supplier catalogue to the back-end online sales software application.

It should be appreciated that the supplier may well be another consumer of the kind as herein described, for example where an online sale is between users of a social classifieds network such as a social media network.

The online sales method may include a prior step of submitting a product of any one or more of: the horizontal market-place supplier and the vertical market-place supplier onto the database. This step may include entering any one or more of the following details of the product: a title for the product; a category of the product from a predefined list of categories; a sub-category of the product from a predefined list of sub-categories; a description of the product; a price for the product; a condition of the product from the selection of any one of new and pre-owned; an estimated product size for delivery by any one of a motorbike, a car, a small utility vehicle and a truck; dimensions of the product in terms of length, width and height; at least one photo of the product; a date from which the product will be available; one or more predefined pick-up day and time slots: a predefined pick-up location; a pick-up address; and an optional paid-for feature listing selection for the product.

The online sales method may include a prior step of submitting a service of any one or more of: the horizontal market-place supplier and the vertical market-place supplier onto the database. This step may include entering any one or more of the following details of the service: This step may include entering any one or more of the following details of the experience: a title for the service; a category of the service from a predefined list of categories; a sub-category of the service from a predefined list of sub-categories; a description of the service; a price for the service; a province in which the service is offered; a location in which the service is offered; at least one photo of the service; a date from which the service will be offered; a date until which the service will be offered; a duration for which the service will be offered; and an optional paid-for feature listing selection for the service.

Naturally, the consumer profile may include consumer contact and address details. In a preferred embodiment, the online sales method may include restricting a view of the consumer profile and hence the consumer contact and address details save for visibility by the consumer and the delivery partner. To this end, the consumer may have a transparent view of delivery progress and transit details.

It should be appreciated that the online sales method as hereinbefore described provides for integration of horizontal and vertical market places wholly within the online sales platform such that consumer interaction is limited to the online sales platform. Accordingly in use, the consumer's interaction with the online sales platform is contained to the platform and the consumer is at no time directed to an outside horizontal or vertical market place.

The invention is now described, by way of non-limiting example, with reference to the accompanying drawings.

### BRIEF DESCRIPTION OF THE DRAWINGS

FIG. 1 illustrates, schematically, an online sales platform in accordance with one aspect of the invention.

FIG. 2 illustrates, schematically, an online sales method according to another aspect of the invention, the method being conducted at the online sales platform of FIG. 1.

In the drawings, like reference numerals indicate like parts unless otherwise indicated.

### DETAILED DESCRIPTION OF THE INVENTION

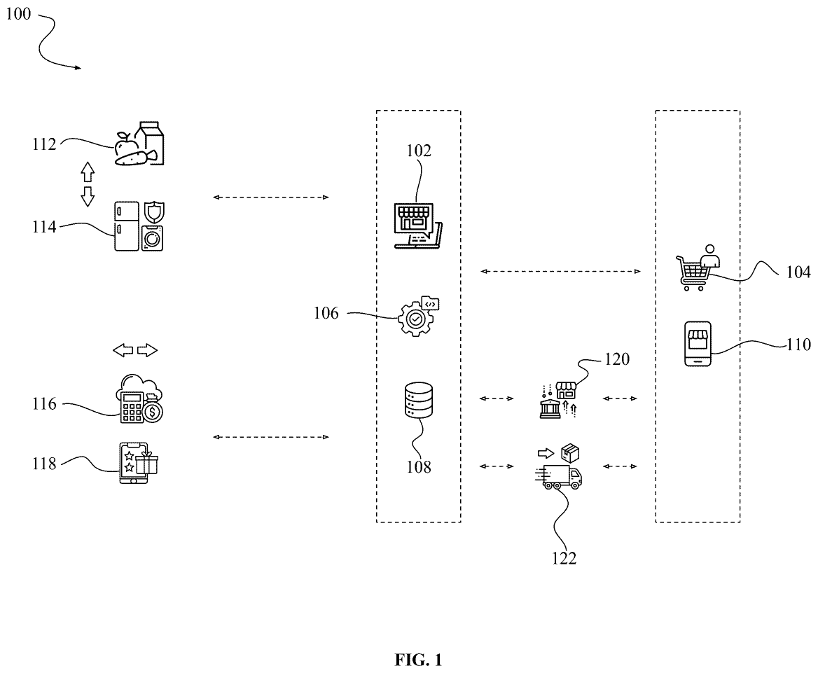

In FIG. 1, reference numeral 100 denotes, generally, an online sales platform according to one embodiment of the invention.

In this embodiment, the platform 100 comprises:
a front-end online sales software application 110 being installed on a device of a consumer 104;
two horizontal market-place suppliers in the form of an accounting software-as-a-service product supplier 116 and a financial loyalty rewards program supplier 118, and
two vertical market-place suppliers in the form of an artisanal e-commerce supplier 112 and a social media classifieds supplier 114; and
an online sales server of a seller 102 having installed thereon a back-end online sales software application 106 and a database 108 in data communication with the front-end online sales software application 110 and the accounting software-as-a-service product supplier 116, the financial loyalty rewards program supplier 118, the artisanal e-commerce supplier 112, and the social media classifieds supplier 114.

The online sales server of the seller 102 is operable to present the consumer 104 with vertical market offerings (i.e. vertical market offerings from the artisanal e-commerce supplier 112 and the social media classifieds supplier 114) at the front-end online sales software application 110.

The online sales server of the seller 102 is also operable to present the consumer with horizontal market offerings (i.e. horizontal market offerings from the accounting software-as-a-service product supplier 116 and the financial loyalty rewards program 188 supplier) at the front-end online sales software application 110.

The online sales server of the seller 102 is then operable to receive any one of a vertical market order and a horizontal market order from the consumer together with a preferred delivery slot from the consumer 104.

The online sales server of the seller 102 is then also operable to receive an available delivery slot from a delivery partner 122.

Next the online sales server of the seller 102 is operable to receive payment for any one of for the vertical market order and the horizontal market order via a payment gateway.

Once the above steps are confirmed the online sales server of the seller 102 is operable to compare the preferred delivery slot from any one of the horizontal or the vertical market place suppliers with the available delivery slot of the consumer 104 and in case of a match, settle on an agreed delivery slot, and in case of a mismatch, receive any one or more of a revised preferred delivery slot and a revised available delivery slot to settle on an alternative agreed delivery slot.

Finally delivering any one of the horizontal- and vertical market order to the consumer 104 in the agreed delivery slot.

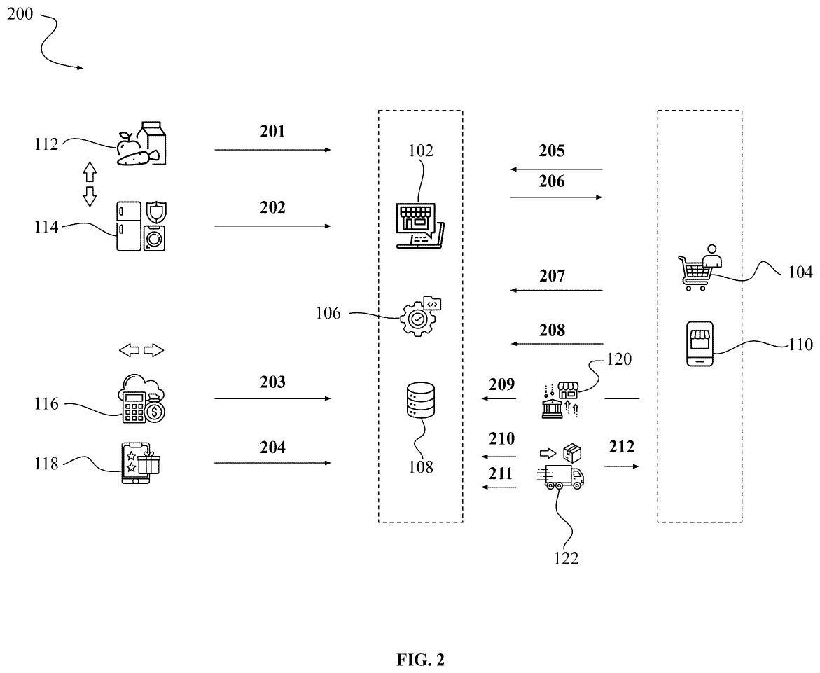

In FIG. 2, reference numeral 200 denotes generally an online sales method according to another embodiment of the invention, the method 200 being conducted at the online sales platform 100 of FIG. 1. The online sales method 200 is conducted at the seller of an online sales platform 100.

At a first step 201, a first vertical market-place supplier is registered, and a first vertical market-place supplier profile is uploaded to the back-end online sales platform 106 of the online sales platform 102. In this embodiment, the first vertical market-place supplier is an artisanal e-commerce supplier 112.

At a next step 202, a second vertical market-place supplier is registered, and a second vertical market-place supplier profile is uploaded to the back-end online sales software application 106 of the online sales platform 102. In this embodiment, the second vertical market-place supplier is a social media classifieds supplier 114.

At step 203, a first horizontal market-place supplier is registered, and a first horizontal market-place supplier profile is uploaded to the back-end online sales software application 106, the first horizontal market-place supplier being an accounting software-as-a-service product supplier 116.

At step 204, a second horizontal market-place supplier is registered, and a second horizontal market-place supplier profile is uploaded to the back-end online sales software application 106, the second horizontal market-place supplier being a financial loyalty rewards program supplier 188.

At step 205, a consumer 104 is registered and a consumer profile is uploaded to the back-end online sales software application 106. In this embodiment of the invention, the online sales method 200 includes a prior step of a product of the horizontal market-place suppliers 116 and 118 and the vertical market-place suppliers 116 and 118 onto the database. This step includes entering any one or more of the following details of the product: a title for the product; a category of the product from a predefined list of categories; a sub-category of the product from a predefined list of sub-categories; a description of the product; a price for the product; a condition of the product from the selection of any one of new and pre-owned; an estimated product size for delivery by any one of a motorbike, a car, a small utility vehicle and a truck; dimensions of the product in terms of length, width and height; at least one photo of the product; a date from which the product will be available; one or more predefined pick-up day and time slots: a predefined pick-up location; a pick-up address; and an optional paid-for feature listing selection for the product.

The online sales method 200 includes a prior step of a product of the horizontal market-place suppliers 116 and 118 and the vertical market-place suppliers 116 and 118 onto the database. This step may include entering any one or more of the following details of the service/experience: a title for the service; a category of the service from a predefined list of categories; a sub-category of the service from a predefined list of sub-categories; a description of the service; a price for the service; a province in which the service is offered; a location in which the service is offered; at least one photo of the service; a date from which the service will be offered; a date until which the service will be offered; a duration for which the service will be offered; and an optional paid-for feature listing selection for the service.

At step 206, the consumer 104 is presented with market offerings from the first and second vertical market-place suppliers, i.e. the artisanal e-commerce supplier 112 and the social media classifieds supplier 114 and presented with market offerings from the first and second horizontal market-place suppliers, i.e. the accounting software-as-a-service product supplier 116 and the financial loyalty rewards program supplier 188.

At step 207, horizontal and vertical market orders are received from the consumer 104 at the back-end online sales software application 106.

At step 208, a preferred delivery slot is received at the back-end online sales software application 106 from the front-end online sales software application 110 of the consumer 104.

At step 209, payment for the horizontal and vertical market offerings is received via a payment gateway 120.

At step 210, an available delivery slot of a delivery partner 122 is received from the delivery partner 122 at the back-end online sales software application, and the preferred delivery slot of the consumer 104 is compared to the available delivery slot of the delivery partner 122, and in case of a match, an agreed delivery slot is settled on, and in case of a mismatch, a revised available delivery slot is received from the delivery partner 122 at step 211 to establish an alternative agreed delivery slot.

At step 212, the vertical and horizontal market orders are delivered to the consumer 104 in the agreed delivery slot.

Advantageously, the online sales method and platform as hereinbefore described is aimed at paving the way in the formation of a new and disruptive market with curated products, services and lifestyle experiences as the only fully integrated end-to-end marketplace across horizontal and vertical domains with on-demand delivery, booking and payment services and enhanced security management.

The method focuses on creating an unparalleled consumer convenience experience, whilst building an ecosystem for organic growth by providing: a fully integrated marketplace “SuperApp” that focuses on bringing fuss-free convenience to consumers through a single source digital application; and a fully integrated end-to-end “SuperApp” offering a range of curated products and services driven by a collaborative business ecosystem.

Advantageously, the method and platform aggregates products, services, events and ticketing and on-demand logistics, leveraging: a network of social-sellers and retail e-commerce sellers to power digital commerce; sole and homegrown artisans and business proprietors to power subscription features and enterprise marketplace; activity agents, role proprietors, restauranteurs and event managers to power a product-as-a-service; partnered proprietors to power points and rewards; the community gig-economy to power on-demand logistics fulfilment services. Sellers and buyers benefit from leveraging advanced technology and business insights to curate and drive a digital commerce journey and gain access to critical mass on the world's fastest runway to product, service and experience discovery.

1. An online sales platform, which includes:
a front-end online sales software application being installed on a device of a consumer, the device of the consumer comprising a display screen, an input device, a processor, a communication interface and memory;
a horizontal market-place supplier and a vertical market-place supplier; and
an online sales server of a seller comprising a display screen, an input device, a processor, a communication interface and memory, the online sales server having installed thereon a back-end online sales software application and a database in data communication with the front-end online sales software application and both the horizontal and vertical market-place suppliers, the online sales server being operable to:
present the consumer with a vertical market offering at the front-end online sales software application;
present the consumer with a horizontal offering at the front-end online sales software application; receive a vertical market order from the consumer;
receive a horizontal market order from the consumer; receive a preferred delivery slot from the consumer;
receive an available delivery slot from a delivery partner;
receive payment for the vertical market order and the horizontal market order via a payment gateway;
compare the preferred delivery slot with the available delivery slot and in case of a match, settle on an agreed delivery slot, and in case of a mismatch, receive any one or more of: a revised preferred delivery slot, and a revised available delivery slot to settle on an alternative agreed delivery slot; and delivering the vertical market order and the horizontal market order to the consumer in the agreed delivery slot.

2. An online sales method being performed on the online sales platform as claimed in claim 1, the method comprising the steps of:
presenting a consumer with an offering via a front-end online sales software application being installed on a device of a consumer;
receiving an order selection from the consumer in response to the offering;
receiving a consumer delivery preference from the consumer;
receiving a delivery partner preference from a delivery partner;
matching the consumer delivery preference to the delivery partner preference;
receiving payment for the order selection; and
delivering the order to the consumer.

3. The online sales method of claim 2, which includes the steps of:
presenting a consumer with a vertical market offering at the front-end online sales software application;
receiving a vertical market order from the consumer at the online sales server having installed thereon the back-end online sales software application and the database;
receiving a preferred delivery slot from the consumer at the back-end online sales software application;
receiving an available delivery slot from a delivery partner at the back-end online sales software application;
receiving payment for the vertical market order via a payment gateway;
comparing the preferred delivery slot with the available delivery slot and in case of a match, settle on an agreed delivery slot, and in case of a mismatch, receive any one or more of: a revised preferred delivery slot, and a revised available delivery slot to settle on an alternative agreed delivery slot; and
delivering the vertical market order to the consumer in the agreed delivery slot.

4. The online sales method of claim 3, in which the vertical market offering includes goods and services specific to any one of an industry, a trade, or a profession.

5. The online sales method of claim 2, which includes
presenting the consumer with a horizontal market offering at the front-end online sales software application;
receiving a horizontal market order from the consumer at the back-end online sales software application;
receiving payment for the horizontal market order via the payment gateway; and
delivering the horizontal market order to the consumer in the agreed delivery slot.

6. The online sales method of claim 5, in which the horizontal market offering includes goods and services that meet the needs of a wide range of buyers across various industries.

7. The online sales method of claim 2, which includes registering a consumer and a supplier and uploading a consumer profile and a supplier profile at the back-end online sales software application.

8. The online sales method of claim 7, in which registering a supplier and uploading a supplier profile includes registering a vertical market-place supplier and a horizontal market-place supplier and uploading a vertical market-place supplier profile and a horizontal market-place supplier profile to the back-end online sales software application.

9. The online sales method of claim 8, which includes uploading a vertical market-place supplier catalogue and a horizontal market-place supplier catalogue to the back-end online sales software application.

10. The online sales method of claim 8, which includes a prior step of submitting a product of any one or more of: the horizontal market-place supplier and the vertical market-place supplier onto the database.

11. The online sales method of claim 10, in which the step of submitting a product onto the database, includes entering any one or more of the following details of the product:
a title for the product;
a category of the product from a predefined list of categories;
a sub-category of the product from a predefined list of sub-categories;
a description of the product;
a price for the product;
a condition of the product from the selection of any one of new and pre-owned;
an estimated product size for delivery by any one of a motorbike, a car, a small utility vehicle and a truck;
dimensions of the product in terms of length, width and height; at least one photo of the product;
a date from which the product will be available;
one or more predefined pick-up day and time slots: a predefined pick-up location;
a pick-up address; and
an optional paid-for feature listing selection for the product.

12. The online sales method of claim 8, which includes a prior step of submitting a service of any one or more of: the horizontal market-place supplier and the vertical market-place supplier onto the database.

13. The online sales method of claim 12, in which the prior step of submitting a service includes entering any one or more of the following details of the service:
a title for the service;
a category of the service from a predefined list of categories;
a sub-category of the service from a predefined list of sub-categories;
a description of the service;
a price for the service;
a province in which the service is offered;
a location in which the service is offered;
at least one photo of the service;
a date from which the service will be offered; a date until which the service will be offered;
a duration for which the service will be offered; and
an optional paid-for feature listing selection for the service.

14. The online sales method of claim 7, in which the consumer profile includes the consumer contact and address details.

15. The online sales method of claim 2, which includes the step of restricting a view of the consumer profile to all parties except the delivery partner.
